(19) United States
(12) Patent Application Publication
(10) Pub. No.: US 2008/0288291 A1
(43) Pub. Date: Nov. 20, 2008

(54) Digital Signature, Electronic Record Software and Method

(75) Inventors: Robert Bartelt, Pottstown, PA (US); Stephen O'Hanlon, Norwood, PA (US); Wade Baugher, W. Conshohocken, PA (US); Dean Martella, Collegeville, PA (US)

Correspondence Address: HOWSON AND HOWSON, SUITE 210, 501 OFFICE CENTER DRIVE, FT WASHINGTON, PA, 19034, US

(73) Assignee: SILVER SPRINGS - MARTIN LUTHER SCHOOL, Plymouth Meeting, PA (US)

(21) Appl. No.: 12/119,131

(22) Filed: May 12, 2008

Related U.S. Application Data
(60) Provisional application No. 60/938,227, filed on May 16, 2007.

(51) Int. Cl. G06Q 50/00

(52) U.S. Cl. 705/3

(57) ABSTRACT

A method and system for managing patient care includes electronically recording medical and demographic information of a patient and developing and electronically recording with the same software program an assessment of the patient including a plan of treatment having defined objectives and goals. Progress notes are periodically entered with the software program. The software program generates prompts for specific data to be input into each progress note. The prompts are automatically generated by the software program based on at least one of the recorded plan of treatment and defined objectives and goals. The progress notes are authenticated and electronically recorded and date stamped by the software program via digital signature and biometric verification such that, after the progress note is recorded, the progress note cannot be altered. Patient progress is tracked with the software program via automated comparisons of the progress notes and the objectives and goals of the plan of treatment.

### CROSS-REFERENCE TO RELATED APPLICATION

This application claims the benefit under 35 USC §119(e) of U.S. Provisional Patent Application No. 60/938,227, filed May 16, 2007.

### BACKGROUND OF THE INVENTION

Formal documentation is often required to be submitted to federal and/or state regulatory agencies or other institutions. As an example, regulatory requirements for documenting behavioral health services provided to children and adults specific to an individualized treatment plan originates in Federal regulations, and such documentation is simultaneously required to be submitted to the Department of Public Welfare (DPW) of the state in which the patient is a resident.

Federal regulations and accrediting organizations such as The Joint Commission (TJC) require that treatment planning be based on the diagnosis and presenting treatment issues. Progress notes documenting service in turn must be specifically related to the treatment issues and the goals and objectives and developed specifically for that individual.

Such documentation is typically required to be executed by the person or persons entering or recording the data or in charge of overseeing the treatment and the documentation must be in a form that is unchangeable.

### SUMMARY OF THE INVENTION

The present invention resolves a number of issues relating to the determination of the diagnosis, identification of the treatment issues and their level of importance, integration of the diagnosis, treatment issues, goals and objectives into progress notes and the management of records and to the authentication of the author of each record. The present invention also provides a means of informing an administrative body of missing records and of documenting services, such as treatment services to clients. More specifically, the present invention relates to software and methods associated with entering, signing, and saving documentation.

Typically clients are referred to organizations by governmental entities and/or managed-care organizations (MCO's). These client referrals and their required treatment are authorized by the purchaser of service for specific periods of time (authorization periods). The treatment planning and reporting facilitated by the software, relates to each authorization period. The software automates the authorization tracking process and relates these time periods to a module which creates HIPAA compliant billing based on the services performed.

According to one aspect of the present invention, a method for managing patient care is provided. The method includes electronically recording with a software program medical and demographic information of a patient, and developing and electronically recording with the same software program an assessment of the patient including a plan of treatment having defined objectives and goals. The method also includes periodically entering progress notes with the software program. The software program generates prompts for specific data to be input into each progress note. The prompts are automatically generated by the software program based on at least one of the recorded plan of treatment and defined objectives and goals. The method also includes authenticating and electronically recording and date stamping each progress note with the software program by digital signature and biometric verification such that, after the progress note is recorded, the progress note cannot be altered. Further, the method includes electronically tracking patient progress with the software program via comparisons of the electronically stored and authenticated progress notes and the electronically stored objectives and goals of the plan of treatment.

According to another aspect of the present invention, a patient care management system is provided. The system includes a patient care management software program accessible on a computer network via a computer interface. The system also includes electronic records of medical and demographic information of a patient stored and accessible by the software program and an electronically recorded assessment of the patient developed, stored, and accessible by the software program. The assessment includes a plan of treatment having defined objectives and goals. The system further includes a set of periodically-entered progress notes electronically entered, stored, and accessible by the software program. Each progress note containing data concerning at least one of the defined objectives of the plan of treatment and at least one prompt automatically generated by the software program based on at least one of the recorded plan of treatment and objectives and goals. The progress notes are authenticated and date stamped via digital signature and a biometric verification such that, after the progress note is recorded by the software program, the progress note cannot be altered. Still further, the system includes comparisons performed by the software program between the data stored in the progress notes and the objectives and goals of the recorded plan of treatment to electronically track patient progress, whereby the software program automates patient care management.

### BRIEF DESCRIPTION OF THE DRAWINGS

FIG. 1 is a sample screen print of the bio-psychosocial section related to determining the admitting diagnoses;

FIG. 2 is a sample screen print of the bio-psychosocial section identifying the treatment issues and their level of importance;

FIG. 3 is a sample screen print of the Achieveit® treatment planning section of the software according to the present invention;

FIG. 4 is the sample screen of the hyperlinked document CLINCIAL PATHWAYS;

FIG. 5 is the sample screen of the CLINICAL PATHWAYS diagnostic list;

FIG. 6 is a sample screen from CLINICAL PATHWAYS presenting brief description of the diagnosis and a list of common presenting behaviors which may be selected;

FIG. 7 is a sample screen from CLINICAL PATHWAYS identifying behaviors that are typically associated with the diagnosis selected on prior screen;

FIG. 8 is a sample screening of the CLINICAL PATHWAYS possible treatment interventions used to suggest “action steps” related to the presenting behavior selected;

FIG. 9 is a sample screen of the described treatment intervention or action step used in creating a treatment plan;

FIG. 10 is a screenshot representing the graph created from Goal Attainment Scaling/ACHIEVEIT scores based on the frequency of the behaviors being monitored;

FIG. 11 is a sample screenshot of a progress note with the prompted questions created by the staff member responsible to document services provided to the client;

FIG. 12 is a screenshot demonstrating the legal disclaimer presented to a staff person prior to there “digitally signing” the progress note;

FIG. 13 is a screenshot of the prompt for the staff members fingerprint identifying them as the author utilizing the M2SYS sensor (“hamster”);

FIG. 14 is a screen shot showing the progress note which is now electronically signed, dated, and time stamped;

FIG. 15 is a screen shot representing the mathematical hash which represents the encrypted digital signature;

FIG. 16 is a schematic view of a digital signature process; and

FIG. 17 is a schematic view of a validation process.

### DETAILED DESCRIPTION OF THE INVENTION

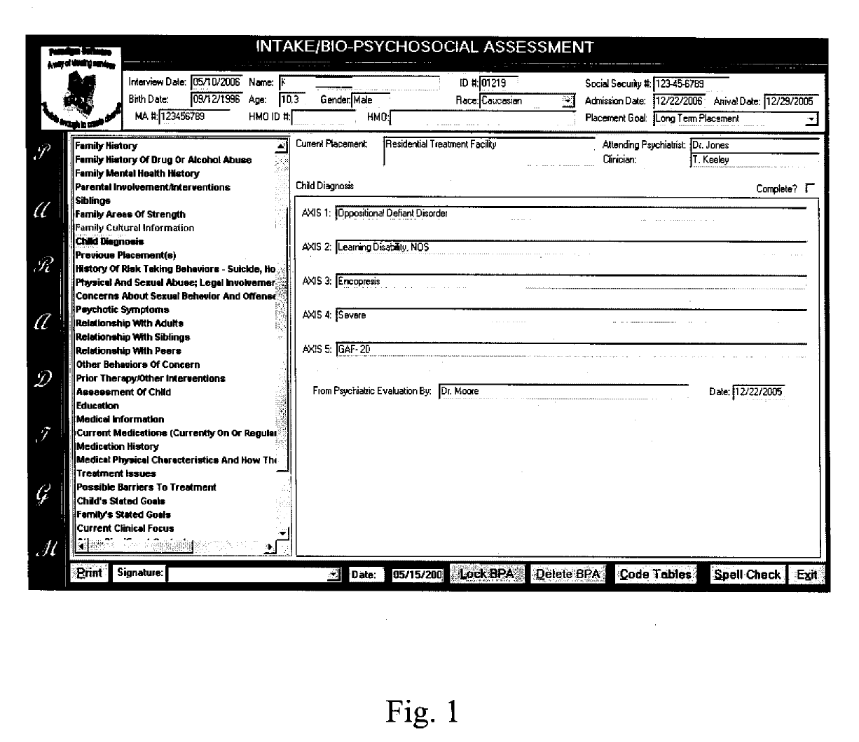

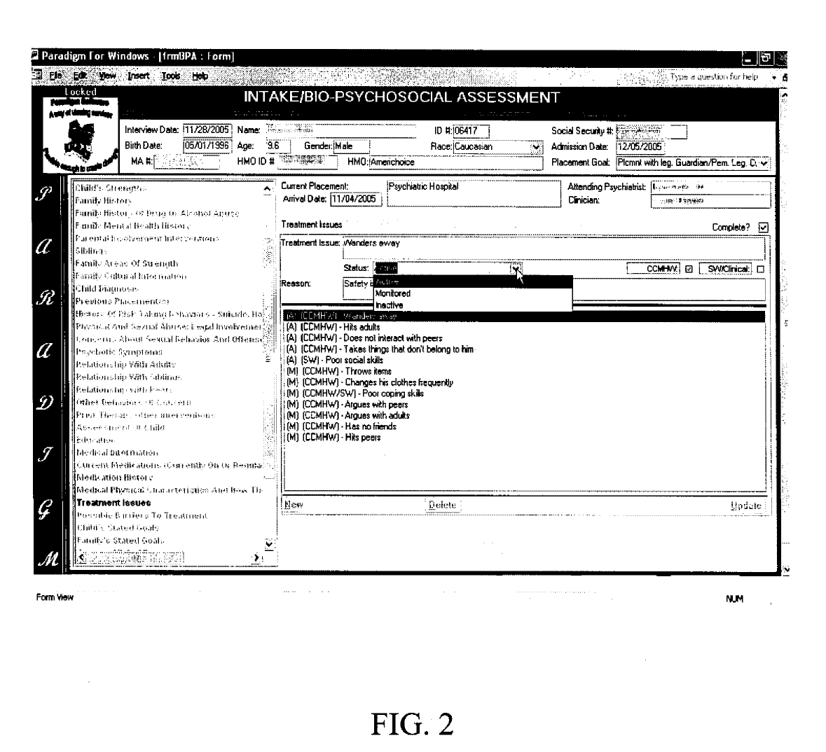

A computer system includes software enabling data to be gathering and stored in electronic format. For instance, with respect to recording behavioral health services, a user enters progress notes electronically into the system. This process begins by gathering information in the bio-psychosocial assessment specific to a client's diagnosis (FIG. 1), identified treatment issues, and the assignment of priority to those treatment issues. Staff determines if the treatment issues are to be active treatment issues, monitored treatment issues, or inactive treatment issues (FIG. 2). To create a full picture of the issues presented which must be considered when developing a treatment plan, the bio-psychosocial assessment section of the software also gathers information on:

Agencies associated with the placement of a client

Reasons for referral to a program

Mother/Father information (when services are provided to) children

Legal Guardianship

Developmental History/Milestones

Child's Strengths

Family History

Family History of Drug or Alcohol Abuse

Family Mental Health History

Parental Involvement/Interventions

Siblings

Family Areas of Strength

Family Cultural Information

Child Diagnosis

Previous Placement(s)

History of Risk-Taking Behavior—Suicidal, Homicidal Ideation

Physical and Sexual Abuse; Legal Involvement

Concerns about Sexual Behavior And Offenses

Psychotic Symptoms

Relationship with Adults

Relationship with Siblings

Relationships with Peers

Other Behavioral Concerns

Prior Therapy/Other Interventions

Assessment of Child

Education

Medical Information

Current Medications (Currently on Our Regularly Taken)

Medication History

Medical Physical Characteristics and How They Impact Treatment

Treatment Issues

Possible Barriers Treatment

Child's Stated Goals

Family's Stated Goals

Current Clinical Focus

Other Significant Contacts

Substance Use/Abuse

Mental Health Plan

Initial Family Visitation Plan

Current Medications in Foster Family Care

Foster Parents

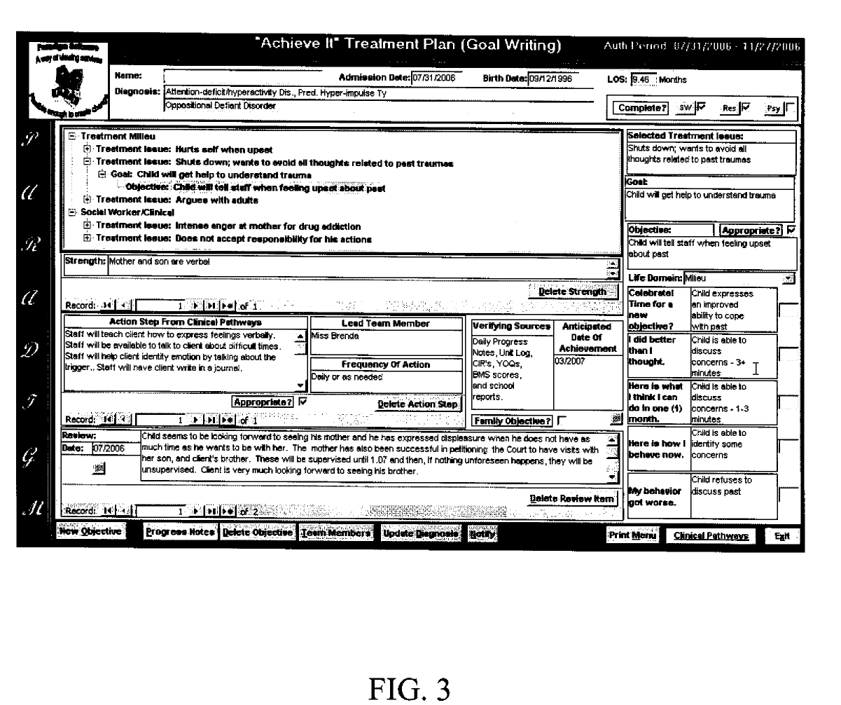

All of this information influences the treatment planning process. The software facilitates effective treatment planning by automating the process—bringing forward the diagnosis and treatment issues developed in the bio-psychosocial assessment so that the progress notes can be specific to the treatment issue, goals and objectives developed for each child (FIG. 3).

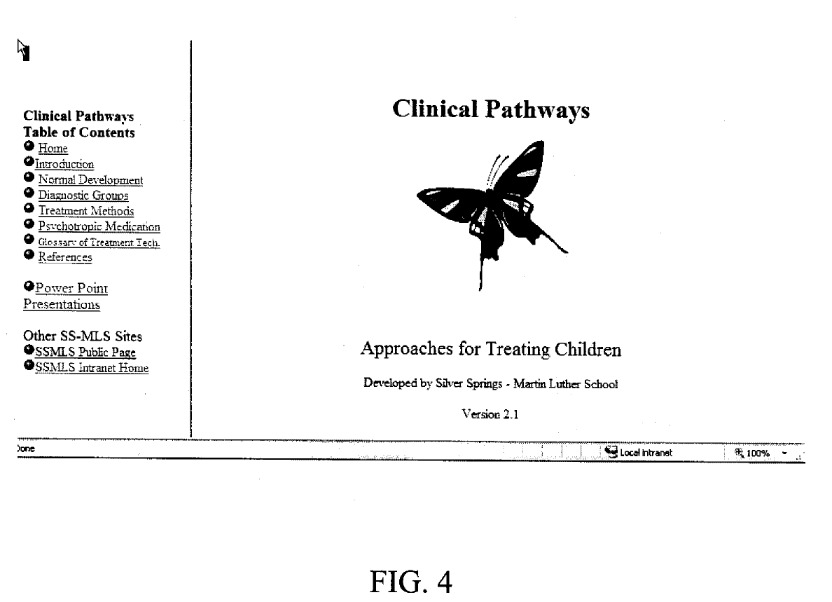

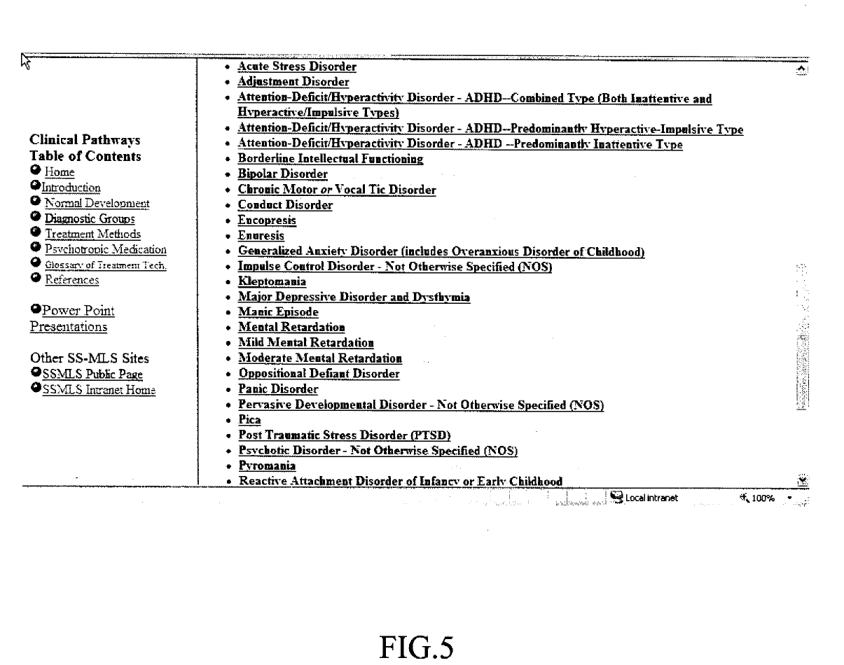

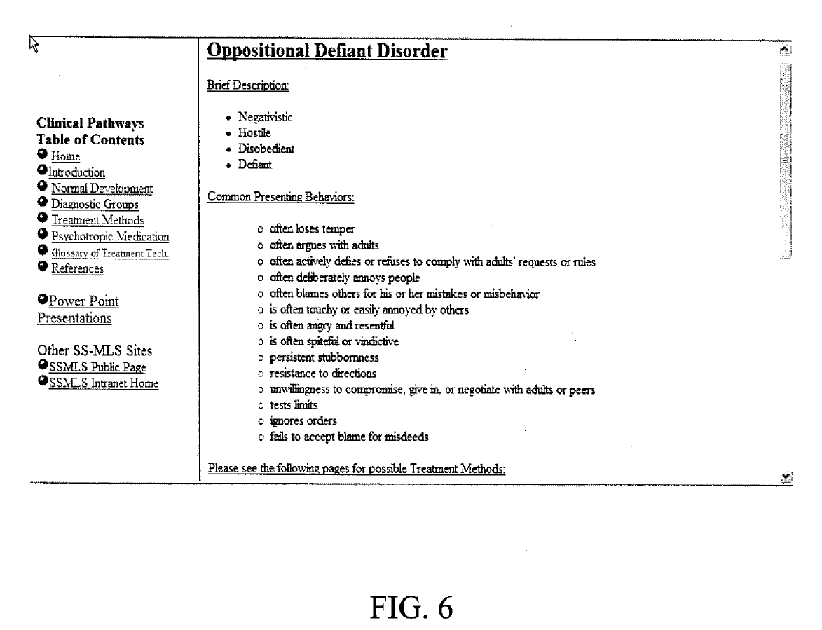

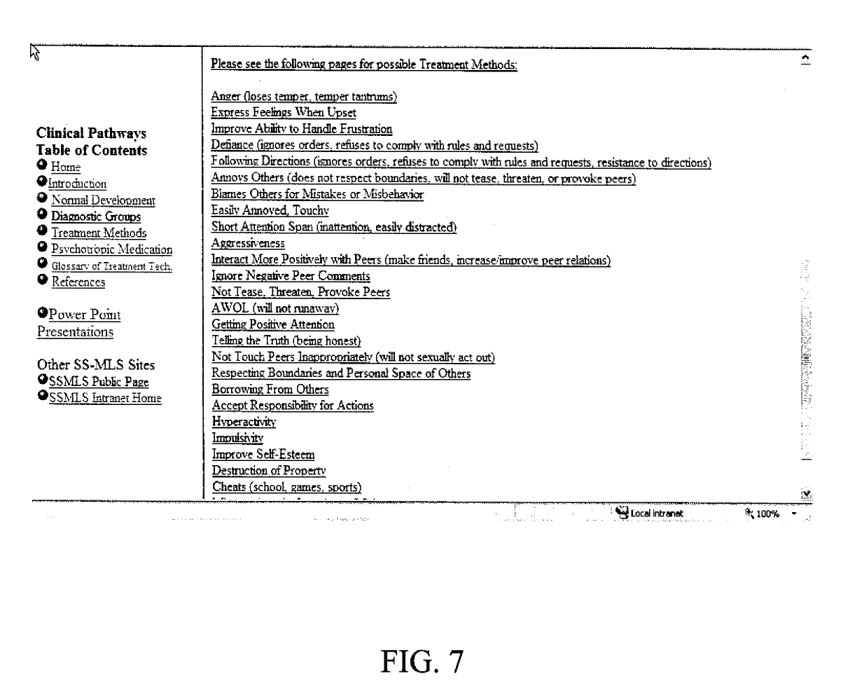

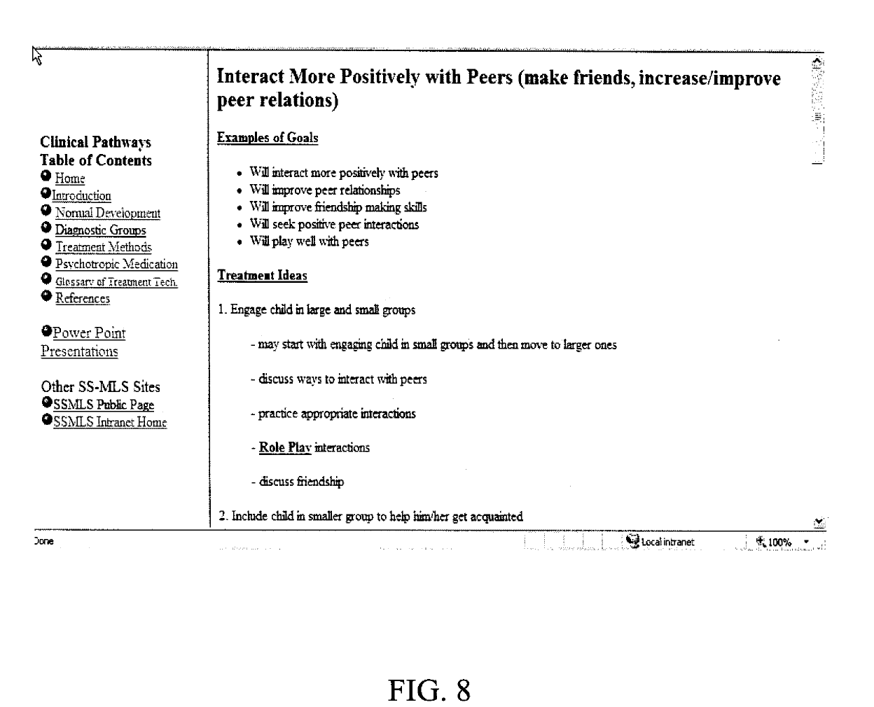

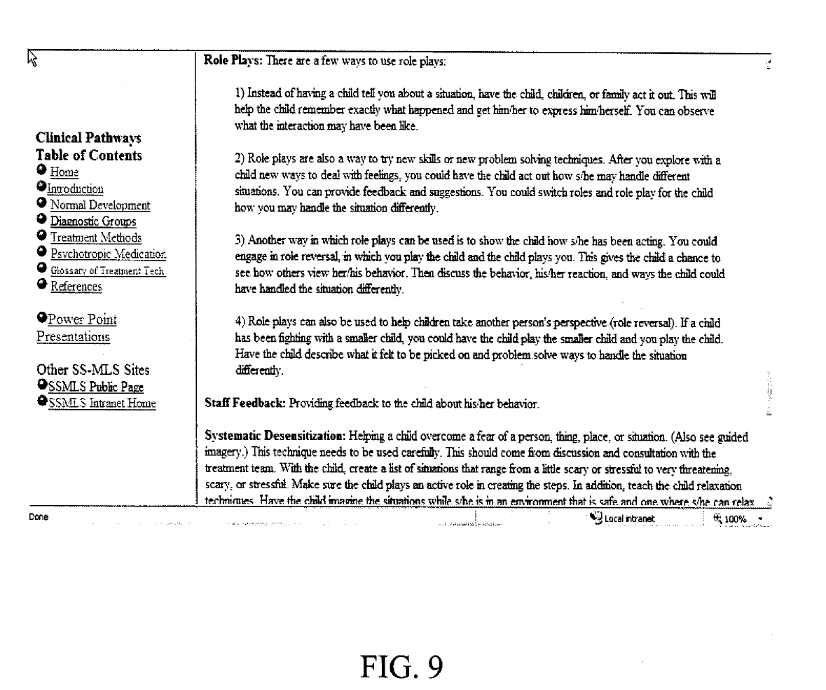

To assist staff in determining the most appropriate “action steps” developed for each objective the software includes a module called, “CLINICAL PATHWAYS” (FIG. 4) which lists typical diagnoses (using the DSM-IV), (FIG. 5), a brief description of the diagnosis and common presenting behaviors typically presented for that diagnostic group (FIG. 6), and an associated behavior list allowing individualization (FIG. 7). Suggested treatment interventions are developed based on these factors (FIG. 8). Possible treatment interventions are then explained to further assist staff in implementing and creating appropriate “action steps” (FIG. 9). (It should be noted that the treatment ideas and suggestions are not a substitute for clinical judgment by trained professionals.)

After the Treatment Issues, Goals and Objectives have been identified, the software prompts staff to identify the frequency of the behaviors being addressed using a non-dichotomous scale. The outcome measurement tool, which has been integrated into the software, uses the model created by Thomas J. Kirsesuk and Sander H. Lund called Goal Attainment Scaling (GAS). This evaluation tool was developed using funding from the National Institute of Mental Health (NIMH, grant number 1 R12 MH2561903).

In an effort to make goal attainment scaling more relevant to children and their families, the scaling system was renamed “ACHIEVEIT” and the scaling terminology was changed for each levels to:

Celebrate! Time for a new objective?

I did better than I thought.

Here's what I think I can do in (1) month.

Here's how I behave now.

My behavior got worse.

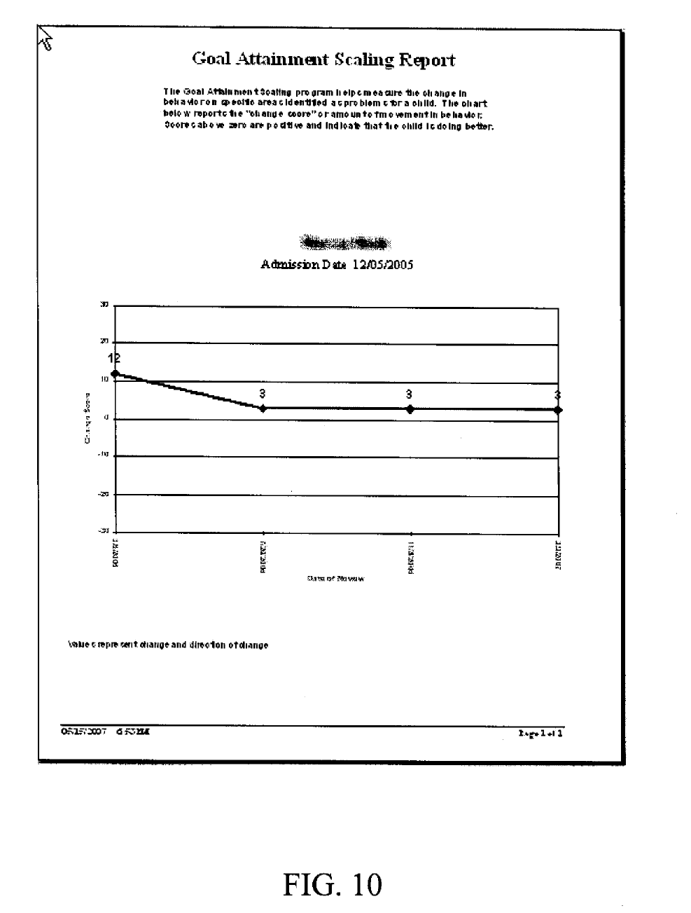

The scaling of each objective/behavioral frequency allows for a composite score using the (GAS) formula, permitting comparison of the initial score versus a follow-up score to create a change score. This creates the ability to measure outcomes of treatment and create outcome measurement reports which track the success of the child's achievement of goals/objectives throughout the course of treatment (FIG. 10).

### Creating the Documentation of Service:

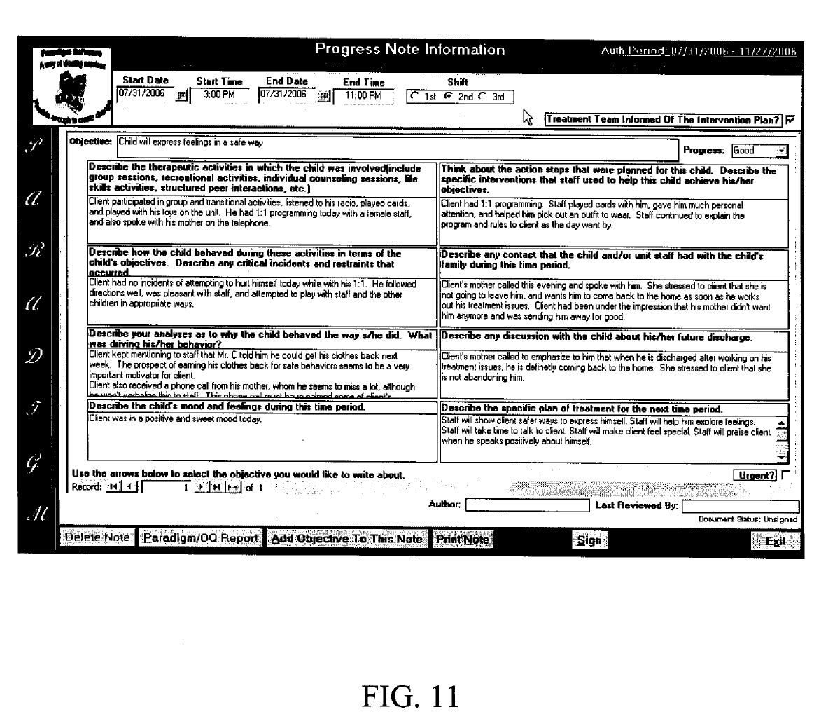

After the treatment plan has been developed, staff is required to create progress notes at a frequency determined either by state and federal regulation or organizational policy. There are several types of progress notes written concerning a client, each with its own set of prompts/questions to be answered. FIG. 11 is a sample screen print of a typical daily progress note written by a clinical staff person.

The software prompts the staff person for which objective is being addressed by the progress note and then, within the progress note itself, information specific to the treatment plan for the patient. The generally accepted method of recording data in the behavioral health field is called a “SOAP” [Subject, Observation, Actions and Plan] note. The prompts assure that needed information is solicited from staff so the note meets the documentation requirements. This note can also be printed as a physical record if needed.

The software facilitates communication among the treatment team by allowing a staff member to check an onscreen “urgent” box if that person considers the progress note to be urgent (such as in the case of a suicidal threat). This choice automatically e-mails the progress note, using external connectors to an e-mail program or through SMTP directly, to a predetermined group identified as the treatment team members.

When the staff person finishes writing the note, they sign it using a signature button at the bottom of the screen. The content of the note can be displayed so that the user can review it. A sample screen is shown in FIG. 11.

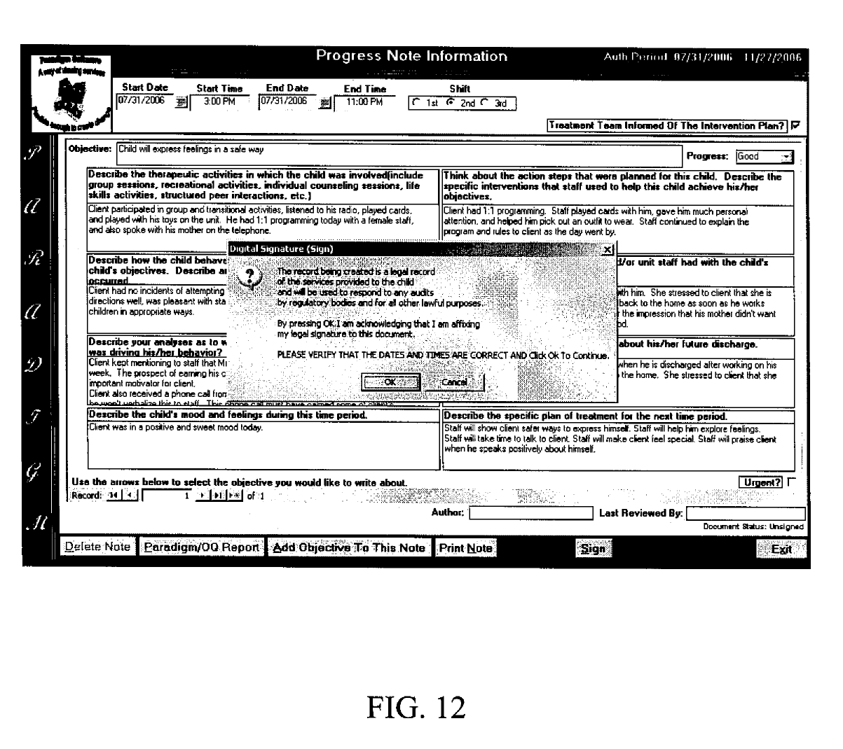

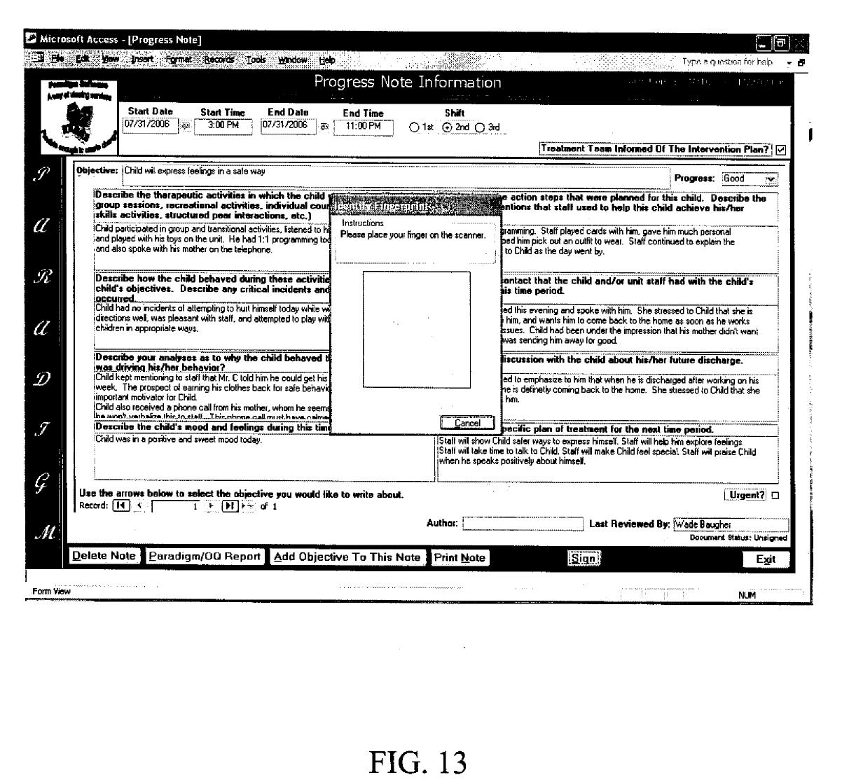

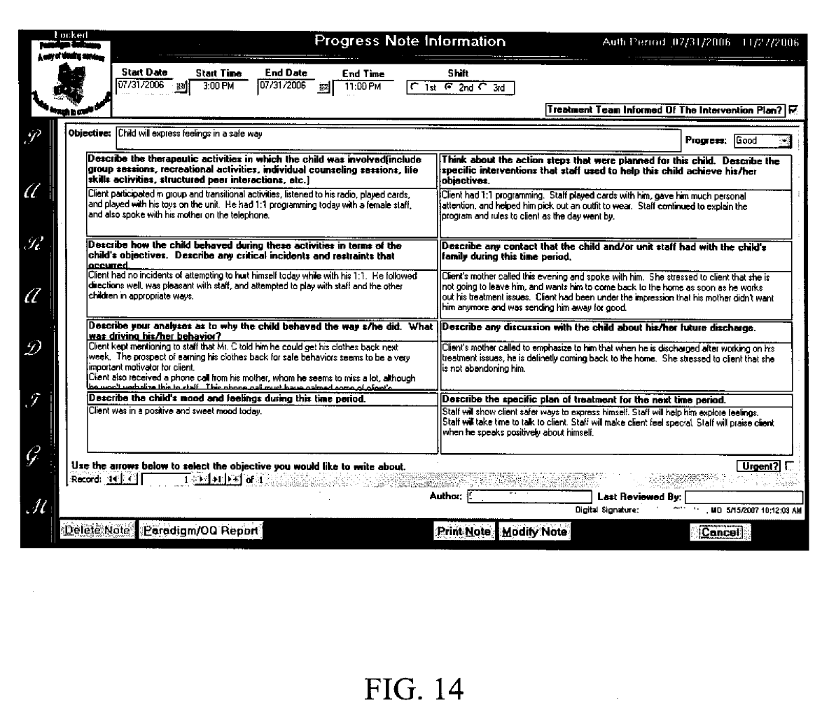

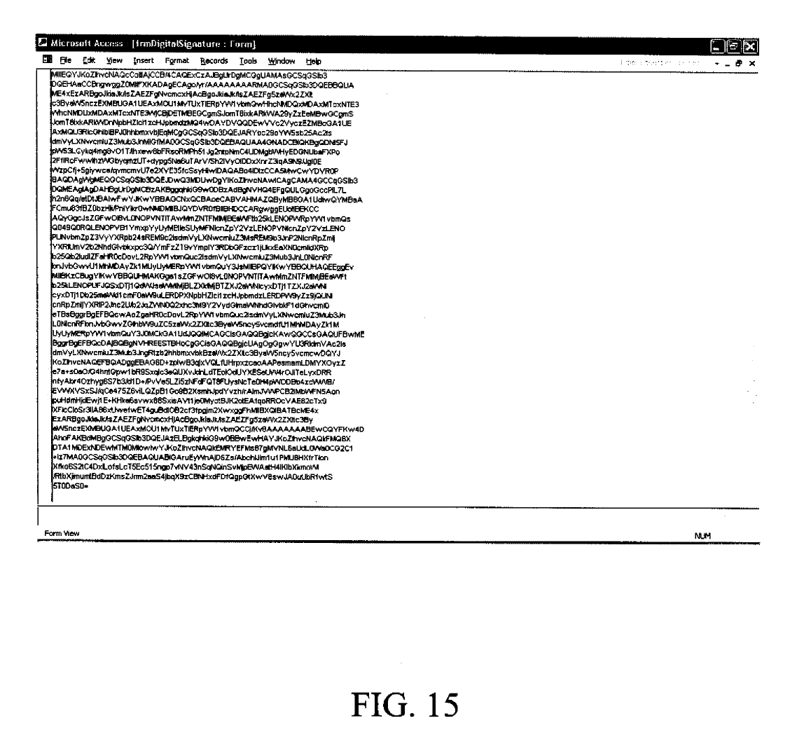

The user is biometrically authenticated (FIG. 13) and presented with a legal disclaimer (FIG. 12). The user clicks the OK button and the content of the note (FIG. 14) and a digital signature (FIG. 15) are stored as part of the progress note record. Once the note has been signed, the system does not allow any changes to be made to the record. However, if changes/additions are necessary, a copy of the note will be made for the user to edit. The copy will have an identifier that links it back to the original note. The same signature process is applied to the new note.

The computer software program and process according to the present invention ties together a number of technologies and helps an organization manage patient care. It has the ability to store medical and demographic information on patients, track patient progress, assist in decision-making, and process billing for services rendered. The software also permits the user to digitally sign important data using state-of-the-art techniques that ensure the identity of the signer and make later alteration impossible.

The software is developed using Microsoft Rapid Application Development Platforms and brings together components such as Microsoft Active Directory, Microsoft Certificate Server, Microsoft SQL Server, Microsoft CAPICOM, and M2SYS's fingerprint technologies to create a seamless, cohesive solution for care management.

### Digital Signature Defined:

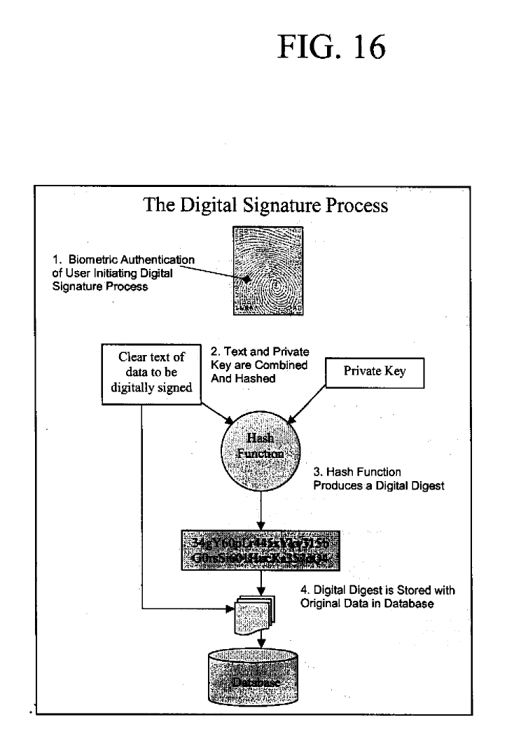

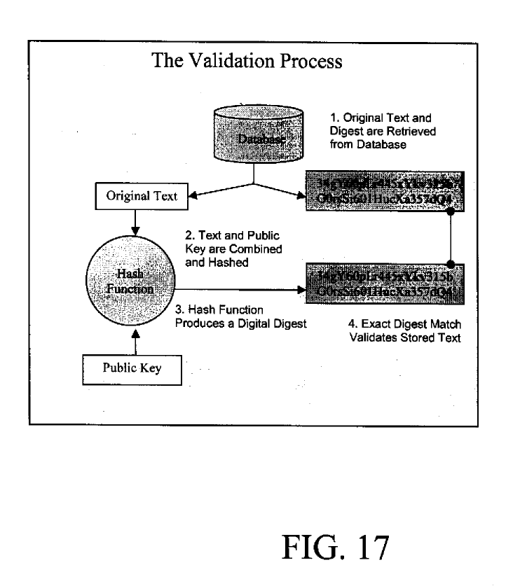

A digital signature is unique digital digest (mathematical summary) created by processing select portions of original data using a hash function. The hash function conforms to defined protocols such as SHA-1. The digital digest is stored along with the original data and can later be used to verify its integrity. The digital digest is a sequence of letters and numbers formed by the computation of the original data and an external authentication mechanism. This external authentication mechanism is usually in the form of a certificate (private key) that, when combined with the original data, creates a certifying code (the digital signature). See FIG. 16. This code can later be “authenticated” through a public key to verify that the original transaction/data has remained unchanged. See FIG. 17, This digital signature can later be used to authenticate both the data and the person who signed it.

The mathematical hash type (digital signature) is important because if the data is altered or the signer changed, it would be apparent through the hash's validation process. The process only succeeds if nothing has changed. Because of this, the hash validation process represents an on-demand guarantee of the fidelity of the original data.

### Digital Signature Process/Authenticate The User:

A biometric fingerprint device is used to scan two different fingers of users who need access to the software application. During the controlled fingerprint capture process, the fingerprint minutiae information and the users' unique identifier related to a network User Name are stored in a database which can be encrypted. With this combination of data, the software can biometrically verify that the person requesting access to the application is the same person who is logged into the network.

When a user attempts to start the software application, they are required to put their finger on a biometric fingerprint device to verify that the fingerprint of the user logging in to the application matches a fingerprint previously captured. Because the fingerprint information database stores a unique identifier related to a network User Name, it additionally verifies that the user is the same person whose network account (through Microsoft Active Directory) is currently being utilized to access the software. Therefore, the software application user must pass two separate layers of security: a network login authentication (user name and password) and a biometric verification. The fingerprint device and its software developed by M2SYS, and used by the software application of the present invention, make use of encrypted HIPAA-compliant techniques to transfer and retrieve the fingerprint minutia and related data. During the authentication process the minutia data is generated by the integrated software application and is based on the network user name of the person whose network account is currently being utilized. If the authentication process fails at any point, the user is denied access to the application.

### Collection of Data:

After a successful user authentication and login to the software application, specific types of data, such as “Progress Notes,” may be recorded and digitally signed. When a user attempts to sign a data record, the user is presented with a notice stating that the digital signature process constitutes a legal signature and will be used to respond to any audits by regulatory bodies and for all other lawful purposes. The user authentication process is restarted. The user is required to put their finger on a biometric fingerprint device to verify that the fingerprint of the user “signing” the record matches a fingerprint previously captured and that the user is the same person whose network account is currently being utilized to access the software. If the authentication fails, the process is terminated and the record remains unsigned (has no digital signature).

Upon a successful authentication, the software application collects and combines all of the relevant data in specific columns of the record being signed. The software application anticipates a predefined number of data columns to include in the collection.

Future enhancements to the software can include the ability to define the number of columns collected on a record-by-record basis, allowing the digital signature process to be more dynamic and flexible. Once the data from the columns has been collected, the labels that describe the columns are incorporated into the collection. The collection is used later in the signing process.

### Request a Certificate:

After the data collection, the software application opens the local certificate store using Microsoft's CAPICOM product and retrieves the first available valid certificate for the logged-in user. If a valid certificate is not found, the digital signature process terminates and the record remains unsigned (has no digital signature).

The user initially receives a certificate, for use in digital signatures, through Microsoft Certificate Server. This can be done manually through that product's web interface or by utilizing the automatic certificate deployment options provided by Microsoft Windows Server 2003 Enterprise Edition.

### Sign the Data:

Upon successful retrieval of a valid certificate, the data collected (as defined previously) is combined with the certificate using an algorithm feature of Microsoft's CAPICOM to create the digital signature. The digital signature is then stored in a separate column as part of the signed record. Some signer information, which includes the name and degree of the signer in addition to the date and time of the signature, is also stored with the digital signature. As soon as the signature process is complete, the system immediately validates the signature using the verification feature of Microsoft's CAPICOM, and the form fields displaying the original data are locked so that no data in the original record can be edited or changed. When a digitally signed record is accessed by the software application at any time in the future, the digital signature is again validated using Microsoft's CAPICOM verification feature to ensure that nothing has changed. If the software application finds any forced or hacked changes in the data, the signature is rendered invalid.

### Co-Sign the Data:

At times, additional signatures are required for previously signed data. When this occurs, the intended co-signer is presented with a notice stating that the digital signature process constitutes a legal signature and will be used to respond to any audits by regulatory bodies and for all other lawful purposes. A fingerprint authentication process is again requested by the software application, which verifies that the person who is co-signing the data is the same person logged into the network on which the application is installed. If the authentication fails, the process is terminated and the record remains un-cosigned (has no digital co-signature).

Upon a successful authentication, the software application immediately validates the original signature using the verification feature of Microsoft's CAPICOM. Upon successful completion of the validation process for the original signature, the software application opens the local certificate store using Microsoft's CAPICOM product and retrieves the first available valid certificate for the logged in user. If a valid certificate is not found, the digital signature process terminates and the record remains un-cosigned (has no digital co-signature).

Upon successful retrieval of a valid certificate, the data collected (as defined previously) is combined with the certificate using an algorithm feature of Microsoft's CAPICOM to create the digital signature. The digital signature is then stored in a separate column as part of the signed record. Co-signer information, which includes the name and degree of the co-signer in addition to the date and time of the signature, is also stored with the digital signature. As soon as the signature process is complete, the system immediately validates the signature using the verification feature of Microsoft's CAPICOM, and the form fields displaying the original data remain locked so that no data in the original record can be edited or changed. When a digitally signed record is accessed by the software application at any time in the future, the digital signature is again validated using Microsoft's CAPICOM verification feature to ensure that nothing has changed. If CAPICOM finds any forced or hacked changes in the data, it returns a code that marks the signature as invalid.

### Change/Modify Signed Data:

Once a record has been digitally signed, the software application locks the form that displays the data so that the data cannot be edited or changed in any way. The original record must remain unchanged. But if changes are required, the software application creates an exact duplicate of the original record and allows only select fields to be edited or changed. The newly created duplicate record is linked to the original using standard database techniques. When the edits are complete in the duplicate record, it goes through the same digital signature process as the original. In this manner, no signed data is ever allowed to be changed or invalidated. Thus, a signed document always remains as originally written and signed.

The software and process according to the present invention can be used in a variety of organizations such as behavioral health service agencies, hospitals and general psychiatric care facilities. Given the services provided by the organization itself, specific questions may need to be answered by the staff/users providing the service to meet Federal, State and/or local guidelines. As in the “progress notes” mentioned above, a set of specific questions are programmed into the software to meet the required organizational and regulatory expectations. The answers to these questions become the stored data that is then digitally signed and verified.

This provides for unlimited flexibility in the software to gather the required data defined by the organization purchasing the software and to meet the specific needs of that organization. It can also prompt an organization's users for the correct data and store that data as a valid, digitally signed record.

While a preferred method, system and software program have been described in detail, various modifications, alterations, and changes may be made without departing from the spirit and scope of the present invention as defined in the appended claims.

1. A method for managing patient care, comprising the steps of:
electronically recording with a software program medical and demographic information of a patient;
developing and electronically recording with the software program an assessment of the patient including a plan of treatment having defined objectives and goals;
periodically entering progress notes with the software program, the software program generating prompts for specific data to be input into each progress note, the prompts being automatically generated by the software program based on at least one of the recorded plan of treatment and defined objectives and goals;
authenticating and electronically recording and date stamping each progress note with the software program by digital signature and biometric verification such that, after the progress note is recorded, the progress note cannot be altered; and
electronically tracking patient progress with the software program via comparisons of the electronically stored and authenticated progress notes and the electronically stored objectives and goals of the plan of treatment;
whereby the software program automates patient care management.

2. A method according to claim 1, further comprising the step of logging a user into the software program via a computer system to enter one of the progress notes, said step of logging a user into the software program includes user name and password login authentication and biometric verification.

3. A method according to claim 2, wherein said step of authenticating and electronically recording progress notes includes a comparison of said biometric verification obtained during said log on step and said biometric verification obtained to authenticate the progress note.

4. A method according to claim 3, wherein the biometric verifications are fingerprint verifications.

5. A method according to claim 4, wherein the patient is a behavioral health service patient and the assessment is a bio-psychosocial assessment.

6. A method according to claim 5, wherein recording the bio-psychosocial assessment includes using the software program to assist in determining a diagnosis, to assist in identifying issues to be treated, and to assign priorities to the identified issues to be treated.

7. A method according to claim 6, further comprising the steps of accessing a module of the software program that includes information on typical diagnosis and suggested treatment interventions and using the suggested treatment interventions to develop action steps for the plan of treatment.

8. A method according to claim 7, further comprising the step of automatically generating a score based on the goals of the plan of treatment and an outcome score based on the data recorded in the progress notes, and wherein the comparisons include comparing the scores and generating a report based on the comparison.

9. A method according to claim 7, further comprising a step of co-signing each progress note with the software program by digital signature and biometric verification of a co-signer.

10. A method according to claim 7, further comprising the step of automatically generating bills for services rendered with the software program from the data of the recorded progress notes.

11. A patient care management system, comprising:
a patient care management software program accessible on a computer network via a computer interface;
electronic records of medical and demographic information of a patient stored and accessible by said software program;
an electronically recorded assessment of the patient developed, stored, and accessible by said software program, said assessment including a plan of treatment having defined objectives and goals;
a set of periodically-entered progress notes electronically entered, stored, and accessible by said software program, each of said progress notes containing data concerning at least one of said defined objectives of said plan of treatment and at least one prompt automatically generated by said software program based on at least one of said recorded plan of treatment and objectives and goals;
said progress notes being authenticated and date stamped via a digital signature and a biometric verification such that after the progress note is recorded by said software program, said progress note cannot be altered; and
comparisons performed by said software program of said data stored in said progress notes and said objectives and goals of said recorded plan of treatment to electronically track patient progress;
whereby the software program automates patient care management.

12. A patient care management system according to claim 11, wherein user name and password login authentication and biometric verification is required by said software program before access to said software program by a user is enabled.

13. A patient care management system according to claim 12, wherein said software program compares said biometric verification obtained during login and said biometric verification obtained to authenticate the progress note before the progress note is authenticated and recorded.

14. A patient care management system according to claim 13, wherein said biometric verifications are fingerprint verifications, and further comprising a mechanism for obtaining fingerprints.

15. A patient care management system according to claim 14, wherein the patient is a behavioral health service patient and said assessment is a bio-psychosocial assessment.

16. A patient care management system according to claim 15, wherein said software program provides a tool for determining a diagnosis, identifying issues to be treated, and assigning priorities to the identified issues to be treated.

17. A patient care management system according to claim 16, wherein said software program includes a module that includes information on typical diagnosis, suggested treatment interventions, and action steps for plans of treatment.

18. A patient care management system according to claim 17, wherein said software program automatically generating a score based on said goals of said plan of treatment and an outcome score based on said data recorded in said progress notes, and wherein said comparisons include comparing said scores and generating a report based on said comparisons.

19. A patient care management system according to claim 18, wherein said software program requires a digital signature and biometric verification of a co-signer before authenticating, date stamping, and recording selected ones of said progress notes.

20. A patient care management system according to claim 19, wherein said software program automatically generates bills for services rendered from said data of said progress notes.
